(19) United States
(12) Patent Application Publication
(10) Pub. No.: US 2019/0165638 A1
(43) Pub. Date: May 30, 2019

(54) Electric Motor Back Cover with a Sealing Structure

(71) Applicant: GP Enterprises Co., Ltd, Suzhou (CN)

(72) Inventor: Xian Wang, Suzhou (CN)

(21) Appl. No.: 16/202,120

(22) Filed: Nov. 28, 2018

Related U.S. Application Data
(63) Continuation of application No. PCT/CN2017/116071, filed on Dec. 14, 2017.

(30) Foreign Application Priority Data
Nov. 29, 2017 (CN) 201711223335.X

(51) Int. Cl. H02K 5/10; H02K 5/132; F04D 13/08; F04D 13/06

(52) U.S. Cl. CPC H02K 5/10; F04D 13/0626; F04D 13/086; H02K 5/132

(57) ABSTRACT

This invention discloses an electric motor back cover with a sealing structure, which includes a cylinder and a cover plate, the cover plate is disposed within the cylinder, and a first O-shaped groove and a second O-shaped groove are concavely arranged on the outer surface of the cylinder, the first O-shaped groove is located above the second O-shaped groove. A position-limitation protruding ring is arranged on the outer surface of the cylinder, and at least one power cord outlets are arranged on the cover plate, and a circle of upward protruding waterproof cofferdam is arranged on the edge of each power cord outlet. The outer wall of the waterproof cofferdam. Via adding waterproof cofferdam on the edge of the power cord outlet is to prevent the condensed water from going into the interior of the motor and improved the stability of use.

### CROSS REFERENCE TO RELATED APPLICATIONS

The present application is a Continuation Application of PCT Application No. PCT/CN2017/116071 filed on Dec. 14, 2017, which claims the benefit of Chinese Patent Application No. 201711223335.X filed on Nov. 29, 2017. All the above are hereby incorporated by reference.

### TECHNICAL FIELD

The present invention relates to a water pump, in particular to an electric motor back cover with a sealing structure which belongs to the technical field of water pumps.

### BACKGROUND OF THE INVENTION

At present, the motor of the household sewage pump usually needs to use an aluminum back cover. The aluminum back cover is light in weight and has good durability.

The traditional back cover has only one sealing structure, it is easy to cause leakage, which causes water to enter the motor and cause the motor insulation failure and the motor easy to be damaged. At the same time, the condensed water inside the motor shell will flow into the interior of the motor sometimes through the power cord outlet which is disposed on the back cover to damage motor, which needs to be improved.

### SUMMARY OF THE INVENTION

The purpose of the present invention is to provide an electric motor back cover which has a sealing structure to strengthen the sealing performance inside and outside of the back cover and avoid condensed water entering into the interior of the motor.

In order to solve the foresaid technical problem, the technical solution of the present invention is provided with an electric motor back cover with a sealing structure, which includes a cylinder and a cover plate, and the cover plate is disposed within the cylinder, and a first O-shaped groove and a second O-shaped groove are concavely arranged on the outer surface of the cylinder, the first O-shaped groove is located above the second O-shaped groove. A position-limitation protruding ring is arranged on the outer surface of the cylinder, and at least one power cord outlets are arranged on the cover plate, and a circle of upwards protruded waterproof cofferdam is arranged on the edge of the each power cord outlet, and the outer wall of the waterproof cofferdam, the inner wall of the cylinder and the upper surface of the cover plate are respectively disposed with a condensed water storage cavity, and the position-limitation ring, the cylinder, the waterproof cofferdam and the cover plate are an integrated structure which can be made of aluminum alloy or other metal, non-metallic materials.

In a preferred embodiment of the present invention, the position-limitation ring is located between the first O-shaped groove and the second O-shaped groove.

In a preferred embodiment of the present invention, the number of power cord outlet is at least one, and the power cord outlets are distributed on the cover plate in a ring-shaped array or other kinds of shaped array.

In a preferred embodiment of the present invention, an upwardly extending bearing seat is disposed in a middle portion of the cover plate and the bearing mounting hole is concavely arranged at the bottom of the bearing mounting seat.

In a preferred embodiment of the present invention, the capacitor mounting hole is provided on the bearing mounting seat.

The beneficial effect of the invention is: The invention provide with an electric motor back cover with a sealing structure, the sealing ring can be installed in the first O-shaped groove and the second O-shaped groove respectively, and the two seals strengthen the sealing performance of the outside of the motor back cover to avoid leakage of internal lubricating oil, it also prevents external water from entering the interior of the motor, adding waterproof cofferdams to the power cord outlet is to avoid condensed water dripping into the interior of the motor, and condensed water can be stored in the condensed water storage cavity and evaporates gradually, this makes the stability of use higher and improves the service life of the motor.

### BRIEF DESCRIPTION OF THE FIGURES

In order to more clearly illustrate the technical solutions in the embodiments of the present invention, the drawings used in the description of the embodiments will be briefly described below. Obviously, the drawings in the following description are merely some embodiments of the present invention. For those who skilled in the art, other drawings may also be obtained based on these drawings without paying any creative work. Therein:

FIG. 1 is a cross-sectional structural illustrative view of a preferred embodiment of an electric motor back cover with the sealing structure according to the present invention;

FIG. 2 is a perspective illustrative view of a preferred embodiment of an electric motor back cover with the sealing structure according to the present invention.

### DETAILED DESCRIPTION

The following is clearly and completely describes of the technical solutions in the embodiments of the present invention. Apparently, the described embodiments are merely some but not all embodiments of the present invention. All other embodiments obtained by a person who is skilled in the art based on the embodiments of the present invention without creative efforts shall fall within the protection scope of the present invention.

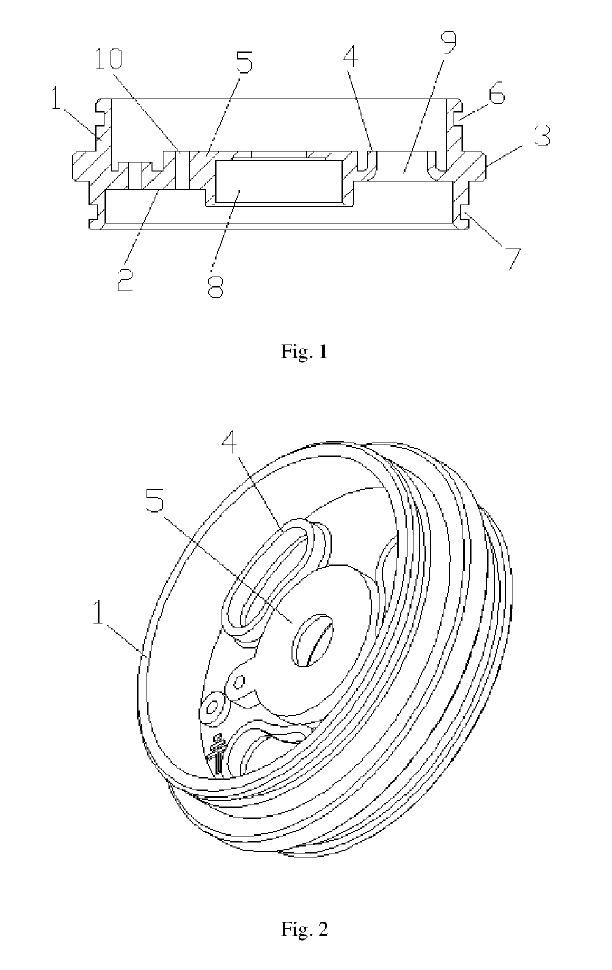

Please refer to FIG. 1-FIG. 2, embodiments of the present invention are set out as the following:

An electric motor back cover with a sealing structure, which includes a cylinder 1 and a cover plate 2, the cover plate 2 which used to support cylinder 1 and motor rotor is disposed within the cylinder 1, and a first O-shaped groove 6 and a second O-shaped groove 7 are concavely arranged on the outer surface of the cylinder 1, the first O-shaped groove 6 is located above the second O-shaped groove 7, the sealing ring can be installed in the first O-shaped groove 6 and the second O-shaped groove 7 respectively, and the two seals strengthen the sealing performance to avoid outer water entering into the motor and leakage of internal lubricating oil, which improves the service life of the motor.

A position-limitation protruding ring 3 is arranged on the outer surface of the cylinder 1, the position-limitation ring 3 is located between the first O-shaped groove 6 and the second O-shaped groove 7 which is convenient for installing motor back cover. The limited-position ring 3, the cylinder 1, the waterproof cofferdam 4 and the cover plate 2 are an integrated structure made of aluminum alloy which is light, strong in structure and good in durability.

The cover plate 2 is provided with 3 power cord outlets 9. A circle of upward protruding waterproof cofferdam 4 is arranged on the edge of the power cord outlet 9. The outer wall of the waterproof cofferdam 4, the inner wall of the cylinder 1 and the upper surface of the cover plate 2 are provided with a condensed water storage cavity, and the condensed water drips into the condensed water storage cavity, the waterproof cofferdam 4 can avoid the condensed water entering into the interior of the motor through the power cord outlets 9, which improves the stability of use.

The three power cord outlets 9 are distributed on the cover plate 2 evenly as a ring array, which facilitates the wiring of the power cord.

An upwardly extending bearing seat 5 is disposed in a middle portion of the cover plate 2 and the bearing mounting hole 8 is concavely arranged at the bottom of the bearing mounting seat 5, which facilitates the installing of the bearing and supports the bearing, the top of the bearing mounting seat 5 extended to the top of cover plate 2, which avoids the adverse effects of condensed water.

The bearing mounting seat 5 is provided with a capacitor mounting hole 10, and the capacitor is placed on the bearing mounting seat 5 and is fixed by a combination of a screw and a capacitor fixing hole 10, which also avoids the effects of condensed water on the capacitor mounting hole 10.

In summary, the invention is provided with an electric motor back cover with a sealing structure, which can strengthen the sealing of the motor and avoid internal lubricating oil leakage and external water entering the interior of the motor, and avoid the influence of condensed water inside the motor, which improves the stability of the use of sewage pump.

The foregoing descriptions are merely embodiments of the present invention, and therefore do not mean to limit the scope of the present invention. Any implementation on the content of the present specification by using an alternative structure or equivalent process transformation without any creative labor should be covered within the scope of protection of the present invention. Therefore, the scope of protection of the invention shall be subject to the scope of protection specified in the patent claim.

What is claimed is:

1. An electric motor back cover with a sealing structure, characterized in that, comprising a cylinder and a cover plate, wherein the cover plate is disposed within the cylinder, and a first O-shaped groove and a second O-shaped groove are concavely arranged on the outer surface of the cylinder, the first O-shaped groove is located above the second O-shaped groove, a position-limitation protruding ring is arranged on the outer surface of the cylinder, and at least one power cord outlets are arranged on the cover plate, and a circle of upwards protruded waterproof cofferdam is arranged on the edge of each power cord outlet, and the outer wall of the waterproof cofferdam, the inner wall of the cylinder and the upper surface of the cover plate respectively disposed with a condensed water storage cavity, and the position-limitation ring, the cylinder, the waterproof cofferdam and the cover plate are integrated to one part

2. The electric motor back cover with a sealing structure according to claim 1, characterized in that the position-limitation ring is located between the first O-shaped groove and the second O-shaped groove.

3. The electric motor back cover with a sealing structure according to claim 1, characterized in that the number of the power cord outlets is at least one.

4. The electric motor back cover with a sealing structure according to claim 1, characterized in that an upwardly extending hearing seat is disposed in a middle portion of the cover plate and a bearing mounting hole is concavely arranged at the bottom of the bearing mounting seat.

5. The electric motor back cover with a sealing structure according to claim 1, characterized in that a capacitor mounting hole is provided on the bearing mounting seat.
